(19) United States
(12) Patent Application Publication
(10) Pub. No.: US 2006/0180402 A1
(43) Pub. Date: Aug. 17, 2006

(54) Installation with belt-like drive means and method for transmission of electrical energy or signals in such an installation

(76) Inventors: Gert Silberhorn, Kussnacht a/Rigi (CH); Daniel Keiser, Cham (CH); Urs Baumgartner, Merenschwand (CH)

Correspondence Address: BUTZEL LONG;DOCKETING DEPARTMENT, 100 BLOOMFIELD HILLS PARKWAY, SUITE 200, BLOOMFIELD HILLS, MI, 48304, US

(21) Appl. No.: 11/318,023

(22) Filed: Dec. 23, 2005

(30) Foreign Application Priority Data
Dec. 24, 2004 (EP) 04106977.4

(51) Int. Cl. B66B 11/08

(52) U.S. Cl. 187/255

(57) ABSTRACT

An installation, such as an elevator installation, has a belt-like drive apparatus driven by friction couple with a drive pulley. The drive apparatus has at least one electrically conductive element extending in a longitudinal direction of the drive apparatus. During operation of the installation, a contact apparatus contacts the at least one electrically conductive element of the moving drive apparatus for transmission of signals and/or electrical energy.

### BACKGROUND OF THE INVENTION

The present invention relates to an installation with a belt-like drive means.

Such installations are typically elevator installations which are equipped with so-termed hanging cables in order to supply an elevator car with current or in order to transmit signals between the elevator car and a control. Disturbances can occur in such elevator installations when the cables are damaged. Moreover, provision and mounting of the cables is complicated in some circumstances. Hanging cables are also used in other installations, such as, for example, crane installations and the like.

According to German Patent Specification DE 10232965 there is recently a move towards replacing hanging cables in that use is made of drive means which have integrated conductors. In that case, however, contact-making with the integrated conductors is difficult, since the current transfer has to be carried out from a stationary location to the conductors embedded in the drive means, while the drive means are moving past this stationary location. In the above-identified patent specification it is therefore proposed to modify the drive pulley of an elevator installation and provide it with contacts. Use is made of a special cogged belt having conductors accessible between the teeth of the cogged belt. During running around the drive pulley, contact locations at the tooth tips of the drive pulley punctiformly engage the conductors in the region of the tooth gaps of the cogged belt.

A disadvantage of this approach is that it can be used only in the case of cogged belts. A further disadvantage is that the drive pulley, which is already a complex and costly component of an elevator installation, is still more complex due to the mounting of the contacts. Moreover, the drive pulley has a central role concerning the safety of an elevator. In practice, therefore, there has rather been a tendency against modification of a drive pulley. Intervention in the region of the tooth gaps leads to weakening of the cogged belt and in the worst case can even impair the load-bearing capability of the belt.

### SUMMARY OF THE INVENTION

It is therefore an object of the present invention to offer a reliable and simple installation as well as a method enabling transmission of energy and/or signals by way of different kinds of belt-like drive means. It is regarded as a further object of the present invention that the assembly of such an installation shall be simplified and able to be carried out without problems. A further object resides in providing an economic solution for energy and signal transmission in such an installation.

The present invention substantially consists in that in the case of an installation with a belt-like drive means, which is driven by a drive pulley and has at least one electrically conductive element for transmission of signals and/or energy—the element extending in a longitudinal direction of the drive means and a contact means being provided to produce contact with at least one electrically conductive element in a region of the drive means which in operation of the installation moves—the force transmission from the drive pulley to the belt-like drive means is carried out by a friction couple.

An installation according to the present invention has the following advantages:

The use of belt-like drive means, which are driven by drive pulleys by means of friction couple, permits a predeterminable limitation of the maximum arising traction force by selection of the friction materials and the looping angle at the drive pulley. In installations in which the possibility exists of the object moved by the drive means being blocked, damage and risks to persons can thereby be avoided.

In elevator installations the friction-locking transmission of traction force to the drive means has the effect that, for example, the elevator car is no longer raised when the counterweight in the case of a control failure moves onto its lower travel limitation, whereby a safety risk is eliminated. It is thus also achieved that the drive unit is not abruptly stopped if the car or the counterweight moves onto its travel limitation, whereby overloads of the entire drive are avoided.

Belt-like drive means, which are driven by friction couple by drive pulleys, are generally simpler and more economic to produce than cogged belts.

In the case of, for example, elevator installations the use of drive means, acting by friction couple, with integrated electrical conductors instead of a toothed drive means makes it possible to dispense with installing a hanging cable for transmission of energy and/or signals. Costs for the material outlay are thereby reduced and the assembly of the installation simplified. Moreover, problems which can arise due to unguided suspension cables, which are therefore susceptible to oscillation, are eliminated.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is a schematic perspective view of a part of an elevator installation according to the present invention;

FIG. 2 is a schematic perspective section view through a part of another elevator installation according to the present invention;

FIG. 3A is a schematic cross-section view through a drive means according to the present invention;

FIG. 3B is a schematic cross-section view through a roller about which the drive means according to FIG. 3A can circulate;

FIG. 4 is a schematic cross-section through a drive means and a contact means according to the present invention;

FIG. 5A is a schematic cross-section through a contact means with presser roller and wedge-rib belt according to the present invention;

FIG. 5B is a schematic view of the contact means, which is shown in FIG. 5A, with the presser roller and the wedge-rib belt in section along the line A-A in FIG. 5A;

FIG. 6A is a schematic cross-section through another embodiment contact means with the presser roller and the wedge-rib belt according to the present invention;

FIG. 6B is a schematic view of the contact means, which is shown in FIG. 6A, with the presser roller and the wedge-rib belt in section along the line A-A in FIG. 6A;

FIG. 7A is a schematic cross-section through a further embodiment contact means with the presser roller and the flat belt according to the present invention;

FIG. 7B is a schematic view of the contact means, which is shown in FIG. 7A, with the presser roller and the flat belt in section along the line A-A in FIG. 7A;

FIG. 8 is a schematic cross-section through a fourth embodiment contact means with presser roller and with a flat belt provided with external conductor tracks according to the present invention;

FIG. 9 is a schematic view of a part of a drive means and a contact means according to the present invention;

FIG. 10 is a schematic cross-section through a further contact means with a wiper contact sliding on electrical conductors in a flat belt according to the present invention;

FIG. 11 is a schematic cross-section through an elevator installation according to the present invention, with a drive unit installed in the counterweight; and

FIG. 12 is a view similar to FIG. 11 of a further elevator installation according to the present invention, with a drive unit installed on the elevator car.

### DESCRIPTION OF THE PREFERRED EMBODIMENT

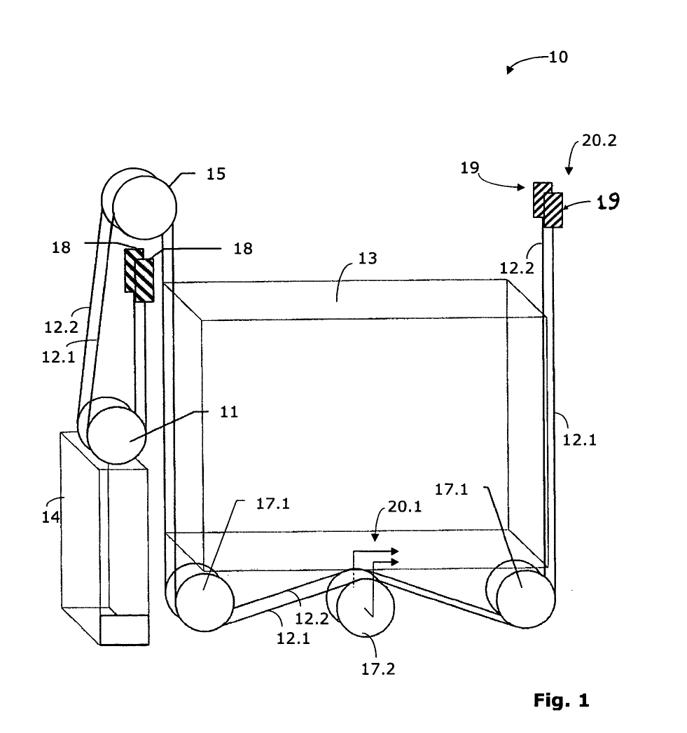

A first embodiment of the present invention is illustrated in FIG. 1. In the case of the example shown in FIG. 1, this is an elevator installation 10 which does not have an engine room and which comprises an elevator car 13. Two drive means 12.1, 12.2 are provided, which extend substantially parallel to one another. In the following description and in FIG. 1 the front drive means is denoted by 12.1 and the rear drive means by 12.2 where this is necessary for better distinction. The ends of the drive means 12.1, 12.2 at the car side are fixed in the region of first drive means fixing points 19 to a guide rail or to an elevator shaft. Each of the drive means 12.1 and 12.2 loops under the elevator car 13, loops around a drive pulley 15 which is connected with a drive unit (not visible in FIG. 1), and carries a counterweight 14. In the illustrated example the drive means 12.1, 12.2 carry the counterweight 14 in that the drive means 12.1, 12.2 run around counterweight rollers 11 and are fixed at the ends, which are at the counterweight side, in the region of two drive means fixing points 18. The looping below the elevator car 13 is effected, in the case of the illustrated form of embodiment, by car support rollers 17.1 which each have a paired layout.

Considered from the counterweight 14, the belt drive comprises the counterweight rollers 11, the drive pulley 15 and the car support rollers 17.1. These rollers are termed guide rollers, since they guide the drive means 12.1, 12.2.

The drive pulley 15, in particular, is mechanically loaded, since here the belt-like drive means 12.1, 12.2 are driven by the drive pulley 15 in order to move the elevator car 13.

According to the present invention at least one of the drive means 12.1, 12.2 comprises at least one electrically conductive element for transmission of signals and/or energy. This transmission can be carried out, for example, from a stationary connecting location 20.2 in the region of the drive means fixing points 19 in the elevator shaft in the region of the drive means end to the elevator car 13 or in an opposite direction. For this purpose the electrically conductive element extends along a longitudinal direction of the drive means 12.1, 12.2. Provided at the elevator car 13 in the region of the drive means 12.1, 12.2 are contact means 20.1 past which at least one of the drive means 12.1, 12.2 moves. A (longitudinal) groove extending parallel to the longitudinal direction of the drive means 12.1, 12.2 is provided at the drive means 12.1, 12.2 with an electrically conductive element. This groove is designed so that it enables the special contact means 20.1 access to the electrically conductive element.

The contact means 20.1 are so constructed and, with respect to at least one of the drive means 12.1, 12.2, so arranged that when the elevator car 13 is moving these drive means 12.1, 12.2 run past the contact means 20.1. In that case the contact means 20.1 produce a permanent contact with the electrically conductive element. In the case of the form of embodiment shown in FIG. 1 the contact means comprise (presser) rollers 17.2.

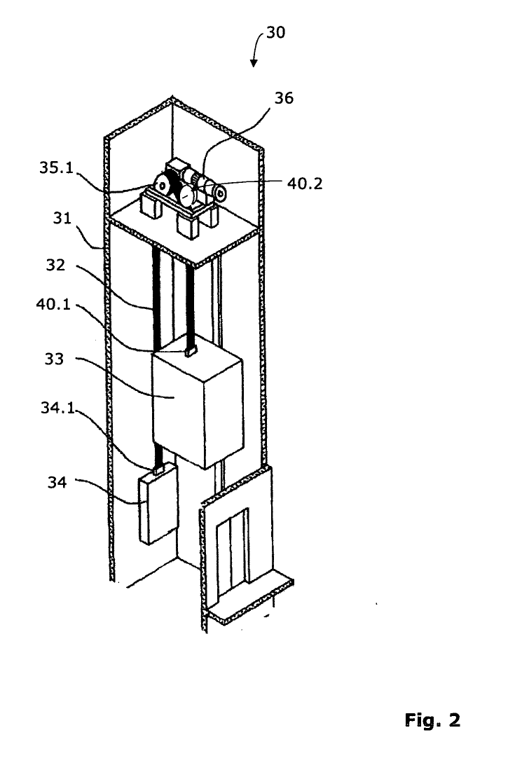

A further or second embodiment of the present invention is now described in connection with FIG. 2. An elevator installation 30 with a belt-like drive means 32 is shown, which is driven by a drive unit 36 by way of a drive pulley 35.1 in order to move an elevator car 33 in a schematically indicated elevator shaft 31. At least one electrically conductive element for transmission of signals and/or energy is provided in the drive means 32. This electrically conductive element extends along the longitudinal direction of the drive means 32. Contact means 40.2 are provided in the region of the drive means 32. The drive means 32 move relative to these contact means 40.2.

At least one groove, which extends parallel to the longitudinal direction of the drive means 32, is provided at the drive means 32. The groove is so formed that it enables access of the contact means 40.2 to the at least one electrically conductive element. The contact means 40.2 are so constructed and, with respect to the drive means 32, so arranged that when the elevator car 33 is moving the drive means 32 run past the contact means 40.2. In that case the contact means 40.2 produce a permanent contact with the at least one electrically conductive element.

In the illustrated form of embodiment a counterweight 34 is fastened by way of fastening means 34.1 to one end of the drive means 32. The elevator car 33 is fastened to the other end of the drive means 32. Considered from the counterweight 34, the drive means 32 loops around the drive pulley 35.1, which can be set in rotation by the drive unit 36. From there, the drive means 32 runs to the elevator car 33. In the illustrated example, the contact means 40.2 are constructed as a presser roller. The presser roller 40.2 is so arranged that it exerts a light pressure on the drive means 32 running past. In the present example the pressure roller 40.2 is seated adjacent to the drive pulley.

Energy, for example, can be fed to the elevator car 33 by way of the contact means 40.2. For this purpose electrical contacts 40.1 which produce permanent electrical connections between the electrical conductors of the drive means and an energy consuming system of the elevator car are preferably provided in the region of the car.

It is regarded as a significant advantage of the present invention that the contact means can be positioned at different locations in an elevator installation. Thus, the stationary location of the contact means can be so selected that it is as favorable as possible for the feed and/or removal of signals and/or energy. Thus, the contact means can, for example, be arranged in the immediate vicinity of the elevator control. Moreover, for example, the contact means can be arranged at locations where they are contaminated as little as possible.

It is even possible to retrofit an existing elevator installation in that a conventional drive means is replaced by a drive means according to the present invention and a contact means is arranged in a region of the drive means which is accessible in every position of the elevator car.

Details of the present invention are explained in the following, wherein reference is made to the figures so far as necessary. The aspects of the present invention which are dealt with can, insofar as not otherwise explicitly mentioned, be used not only in connection with the form of embodiment shown in FIG. 1, but also in connection with the form of embodiment shown in FIG. 2. In that case it is to be noted that FIGS. 1 and 2 are purely schematic in nature and were selected in order to show basic elevator configurations.

In FIG. 1 the two drive means 12.1, 12.2 are used. However, the present invention is generally usable with any elevator installation having at least one belt-like drive means. In FIG. 2 an embodiment with only one drive means 32 is shown.

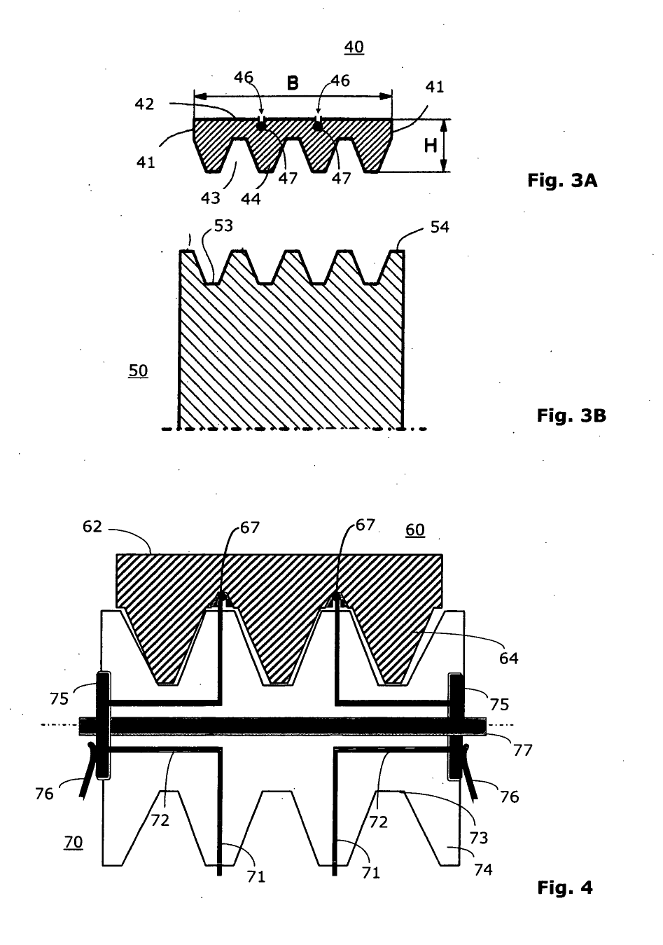

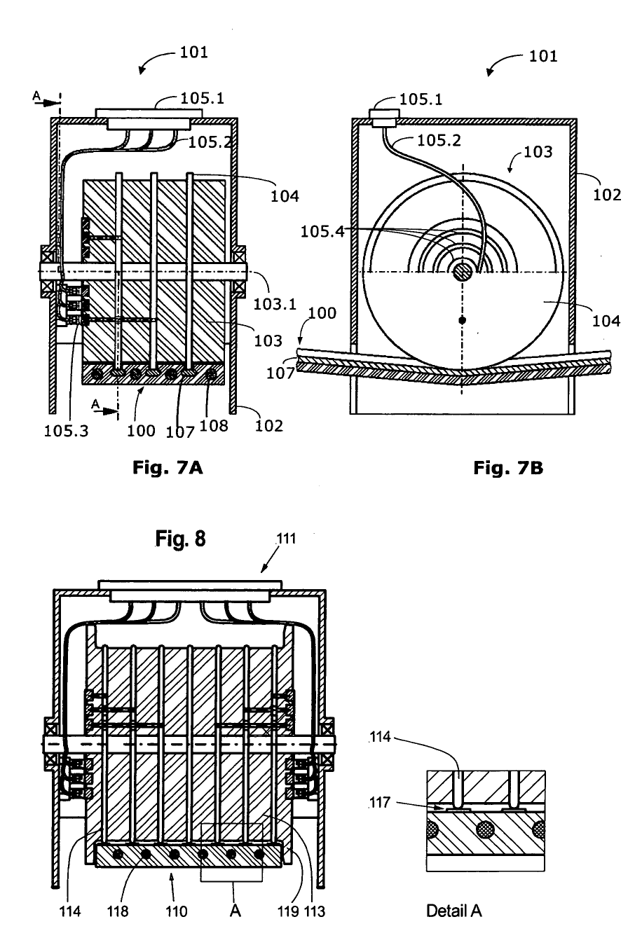

As belt-like drive means there is denoted, in the present context, a drive means which has a longitudinal direction and a substantially rectangular cross-section and is flexible in itself. Cited as typical examples are the flat belt (cf. FIGS. 7A and 7B), the cogged belt and the wedge-rib belt (cf. FIGS. 3A, 4, 5A, 5B, 6A, 6B), wherein this listing is to be understood as not limitative.

A section through a wedge-rib belt 40 is shown in FIG. 3A. The section extends perpendicularly to the longitudinal axis of the belt 40. The wedge-rib belt 40 has a front side with four ribs 44 and three rib intermediate spaces 43, a substantially flat rear side 42 and two side walls 41. A part of a roller 50 of the belt drive is shown in FIG. 3B. The roller 50 has a structured cylindrical casing having encircling grooves 53 and ribs 54. These are preferably so formed that they guide the belt 40 when this runs around the roller 50. The roller 50 can serve as, for example, a drive pulley.

According to the embodiment of the present invention shown in FIG. 3A the belt 40 has on its rear side 42 at least one (longitudinal) groove 46, which extends parallel to the longitudinal axis of the belt 40. In the present example two of the grooves 46 are present. Two electrical conductors 47 are embedded in the belt 40 below the grooves 46. These conductors 47 are of flexible construction and extend parallel to the longitudinal axis of the belt 40.

The electrical conductors 47 in the drive means can have any cross-sectional shapes, wherein round or oval cross-sections are preferred. Preferably use is made of conductors which form wire cables produced from fine wires and comprise several strands. Copper alloys with strength characteristics optimized for this application are particularly suitable as wire material.

The electrical conductors can also be metal strips consisting of, for example, spring bronze.

Advantageously the electrical conductors in the case of production of the belt-like drive means are integrated therein. In the case of a preferred production method the electrical conductors go into the drive means in that they—in common with tensile carriers—are embedded in the belt casing during production thereof by means of extrusion. The requisite longitudinal grooves are produced in the same extrusion process.

The electrical conductors in the drive means can also be realized by plating flexible foils of copper alloys, wherein the foils are fixed, for example, by gluing on the rear side of the drive means or at the base of longitudinal grooves in the drive means. In that case the foils should preferably be arranged in the region of the neutral zone of the flexible drive means.

The embodiment shown in FIG. 3A is preferred, since the electrical conductors 47 and the grooves 46 are disposed on the belt rear side 42. This belt rear side 42 has little mechanical loading, since typically only the front side of the belt 40 runs over the drive pulley and is exposed to higher loads as a consequence of the transmission of traction. The belt rear side 42 is substantially freely accessible.

Such a wedge-rib belt can advantageously be used as a friction-locking (adhesion-locking) traction element. The wedge-rib belt enables, in the case of similar running characteristics as a flat belt, a higher cable force ratio by virtue of its shape. A further advantage of the wedge-rib belt is that it is self-centering. Moreover, a wedge-rib belt runs much more quietly than, for example, a cogged belt.

The belt-shaped drive means can, according to the present invention, be equipped with tensile carriers in the form of metallic (for example, steel or copper strands) or non-metallic strands (for example, aramid strands), chemical fibers P.B.O. (called Zylon, a trademark of Toyo Boseki Kabushiki Kaisha, Ta Toyobo Co., Ltd. of Japan) or the like in order to impart an additional tensile strength and/or longitudinal strength to the drive means.

The electrically conductive elements present in the drive means according to the present invention serve for transmission of electrical energy and/or for transmission of signals (analog and/or digital), for example from a stationary location to an elevator car or to a counterweight.

Thus, for example, an energy consuming system in the elevator car, for example the lighting or a fan, can be supplied with power by way of the drive means and the conductors thereof. Such an electrical connection can also serve the purpose of supplying power to an elevator drive arranged in an elevator counterweight or electrically activating a safety brake device mounted thereat. The energy source can, for example, be seated at a suitable location in the elevator shaft. It is conceivable that an electrical conductor in the drive means conducts a positive voltage to the consuming system in the elevator car, wherein the ground path is produced at the elevator car by way of a guide rail of the elevator car.

The drive means with electrical conductors can, however, also be used for signal transmission. Thus, for example, a request call or an emergency call of the elevator car can be passed by way of the electrical conductors of the drive means to a control in the elevator shaft. For this purpose, for example, a form of bus connection between the elevator car and a control or a computer can be realized by way of the drive means.

In a ‘hybrid version’ not only the energy supply, but also the signal transmission can be carried out by way of conductors of the drive means. Thus, for example, in order to reduce the number of necessary conductors the signals to be transmitted can be modulated on the energy-conducting conductors. Thus, for example, in the case of suitable wiring not only the elevator car can be supplied with energy, but also the communication between elevator car and control can be managed.

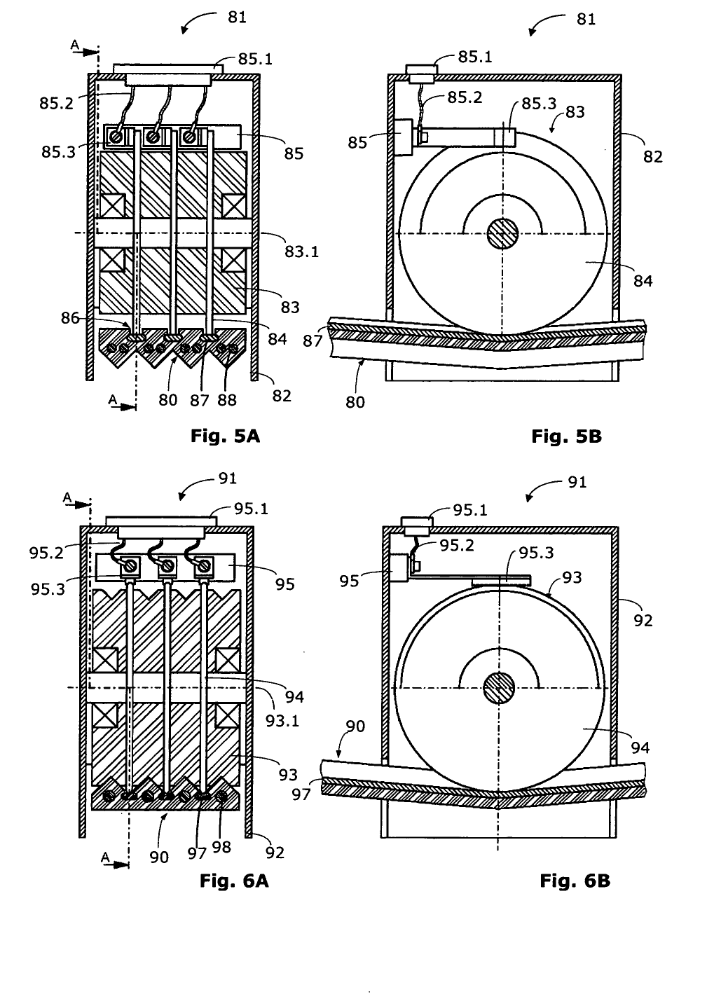

The tensile carriers, thus present, can be recognized in FIGS. 5A, 6A and 7A. They take over, apart from increase of tensile strength, also the electrical functions.

In FIG. 4 there is schematically shown a further embodiment wedge-rib belt 60 which co-operates with a contact means in the form of a presser roller 70. The wedge-rib belt 60 has three ribs 64. In the illustrated example electrical conductors 67 are seated in the two rib intermediate spaces in a groove specifically for that purpose. The grooves are accessible from a front side 62 of the wedge-rib belt 60. In the illustrated example, the belt 60 runs around the presser roller 70 which has a structured cylindrical circumferential surface with four ribs 74 and three rib intermediate spaces 73. Two metallic discs 71 are incorporated in the presser roller 70 and protrude beyond the crests of the ribs 74. The discs 71 are so constructed that they engage in the grooves of the belt 60 and there produce contact with respect to the conductors 67. Two conductive sleeves 72, which are electrically connected with the discs 71, are arranged coaxially with respect to an axle 77 of the roller 70. Two electrically conductive discs 75 are seated in corresponding recesses in the region of the two end faces of the roller 70. The discs 75 are respectively conductively connected with the sleeves 72. Wiper contacts 76, for example, can be pressed from outside against the disc 75, as indicated in FIG. 4. An electrically conductive connection with the conductors 67 can be produced by way of these wiper contacts 76, the discs 75, the sleeves 72 and the discs 71.

A further embodiment of an installation according to the present invention with a drive means 80 and a contact means 81, which comprises a presser roller 83, is shown in FIG. 5A and in FIG. 5B. A schematic cross-section is shown in FIG. 5A. FIG. 5B shows a section along the line A-A in FIG. 5A. The drive means is a wedge-rib belt 80 having four ribs and three rib intermediate spaces. Tensile carriers, which are preferably present in the form of steel wire strands, are illustrated by the reference numeral 88. Three (longitudinal) grooves 86 extending parallel to the longitudinal axis of the belt 80 are provided on the rear side of the belt 80 in the illustrated example. Three electrical conductors 87 are provided in the belt 80. The conductors 87 similarly extend parallel to the longitudinal axis of the belt. These conductors 87 are flexible and, depending on the respective design of the belt and the conductors 87, can also take over support functions sufficiently to the electrical functions. The belt 80 comes into contact at its rear side with contact discs 84 of the presser roller 83. These contact discs 84 engage in the (longitudinal) grooves 86 and produce an electrically conductive contact with respect to the conductors 87.

As schematically indicated in FIG. 5A and in FIG. 5B the presser roller 83 is a rotatably mounted roller with a roller axis 83.1. When the drive means 80 moves past the presser roller 83, the presser roller 83 is set into rotation, wherein the circumferential speed at the outermost circumference of the contact discs 84 approximately corresponds with the speed of the drive means 80. There thereby results a situation in which a permanent, non-wiping electrical connection is present between the contact discs 84 and the conductors 87.

A form of the embodiment in which a minimum looping angle is present between the drive means 80 and the contact discs 84 is particularly preferred, for example a looping angle of more than three degrees, in order to thereby obtain a largest possible contact area.

The contact means 81 preferably comprise a housing 82 in order to offer protection against unintended contact with voltage-conducting parts and against contamination.

In the illustrated embodiment three wiper contacts 85.3, which produce an electrically conductive connection with the individual contact discs 84, are provided above the presser roller 83. The wiper contacts 85.3 are connected by way of cables 85.2 with a plug contact 85.1 or the like. The three wiper contacts 85.3 are seated on a rail 85 of insulating construction. A connection, for example with the elevator control, can be produced by way of the plug contact 85.1.

A further embodiment of the present invention is shown in FIGS. 6A and 6B. In the following there is discussion only of the essential elements of this embodiment, since in principle they correspond with the embodiment shown in FIGS. 5A and 5B.

A contact means 91 is shown, which comprises a presser roller 93 and produces contact with respect to electrical conductors 97 embedded in a drive means 90. The drive means 90 is a wedge-ribbed belt 90 which has four ribs and three rib intermediate spaces as well as a number of tensile carriers 98. In the illustrated example the belt front side runs around the presser roller 93 and the presser roller 93 is appropriately structured at its circumference.

In the illustrated example three (longitudinal) grooves (not recognizable in FIGS. 6A and 6B), which extend parallel to the longitudinal axis of the belt 90, are provided on the front side of the belt 90. Three of the electrical conductors 97 are provided in the region of these grooves in the belt 90. The belt 90 comes into contact at its front side with contact discs 94 of the presser roller 93. These contact discs 94 engage in the (longitudinal) grooves and produce an electrically conductive contact with respect to the conductors 97.

As schematically indicated, the presser roller 93 is also a rotatably mounted roller with a rotational axis 93.1 and there results a situation in which a permanent, non-wiping connection arises between the contact discs 94 and the conductors 97.

An embodiment is particularly preferred in which, as apparent from FIG. 6B, the drive means 90 loops around the contact discs 94 by a minimum looping angle in order to thereby obtain a largest possible contact area.

The contact means 91 preferably comprise a housing 92 in order to provide protection against unintended contact with voltage-conducting parts and against contamination. Also illustrated are three wiper contacts 95.3, which produce an electrically conductive connection with the individual contact discs 94. The wiper contacts 95.3 are connected by way of cables 95.2 with a plug contact 95.1 or the like, and are seated on a rail 95 of insulating construction.

Another embodiment of the present invention is shown in FIGS. 7A and 7B. Only the essential elements of this embodiment are discussed in the following, since in principle they correspond with the embodiment shown in FIGS. 5A to 6B.

A contact means 101 is shown, which comprises a presser roller 103 and produces a contact with respect to a drive means 100. The drive means 100 is a flat belt. Three electrical conductors 107 and four tensile carriers 108 are provided in the belt 100. The belt 100 comes into contact, at one side, with contact discs 104 of the presser roller 103. These contact discs 104 engage in the (longitudinal) grooves and produce an electrically conductive contact with respect to the conductors 107.

As schematically indicated the presser roller 103 is also a rotatably mounted roller (wherein this roller is mounted in different manner than in the previous cases) with a rotational axis 103.1, and a situation results in which a permanent, non-wiping connection arises between the contact discs 104 and the conductors 107. Three wiper rings 105.4 are provided at one of the end surfaces of the presser roller 103. Wiper contacts 105.3 are axially pressed against these wiper rings 105.4 in order to produce a contact between the individual contact disc 104 and a plug connection 105.1. Cables 105.2, for example, can be provided between the wiper contacts 105.3 and the plug connection 105.1.

An embodiment in which, as apparent from FIG. 7B, the drive means 100 loops around the contact discs 104 by a minimum looping angle, in order to thereby obtain a greatest possible contact area, is particularly preferred.

The contact means 101 preferably comprises a housing 102 in order to offer protection against unintended contact with voltage-conducting parts and against contamination.

FIG. 8 shows equipment according to the present invention, in which a belt-like drive means 110 has electrical conductors in the form of flat conductor tracks 117, which are applied to the outer side of the casing of the drive means and which are produced, for example, from metal alloys with good conductivity. Where the belt guide permits this, the conductor tracks 117 are applied to a rear side, which does not come into contact with belt pulleys, of the drive means 110. The conductor tracks 117 are usually fixed by means of adhesive to the casing of the drive means, but can also be coated by known chemical and/or physical plating methods onto the casing material. The drive means 110 in the form of a flat belt with tensile carriers 118 and a casing, which preferably consists of polyurethane, is illustrated. A contact means 111 also comprises in this case a presser roller 113 with a number of contact discs 114 by way of which the conductor tracks 117 can be contacted. The presser roller 113 is in this case equipped with lateral flanges 119 in order to ensure lateral guidance of the drive means 110 and thus correct co-operation of contact discs 114 and conductor tracks 117. In the case of such an embodiment with conductor tracks applied to the outer side of the drive means and not protected against contact it is useful, for safety reasons, for the transmission of electrical energy and signals to use transmission systems with voltages of less than fifty volts.

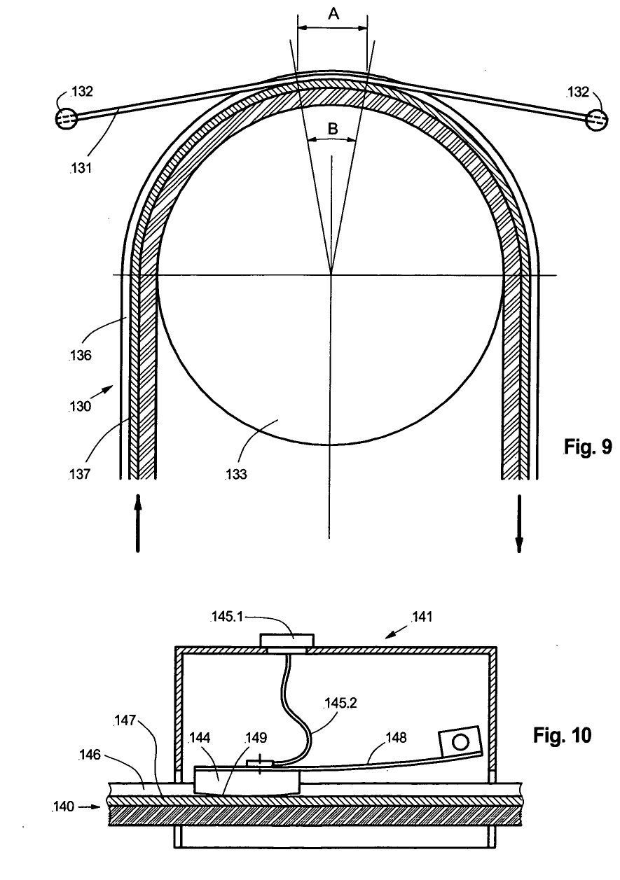

In further embodiments, which are schematically indicated in FIG. 9 and FIG. 10, the contact means are not part of a roller or a disc. The illustration shown in FIG. 9 is a section through a belt-like drive means 130 (flat belt) which runs over a deflecting or pressing roller 133. The deflecting or pressing roller 133 presses against the drive means 130 according to the present invention, which contains an electrical conductor 137 embedded therein. A (longitudinal) groove 136 is provided on the rear side of the drive means. An electrically conductive cable 131, for example a steel cable, is tightened above the roller 133 between two fastening points 132. The fastening points 132 lie somewhat above the uppermost turning point of the drive means 130. It is thereby achieved, as illustrated in FIG. 9 in somewhat exaggerated form, that the cable 131 engages not only in the groove, but also tightens around the electrical conductor 137 on the belt rear side by a looping angle “B” of at least five degrees, preferably ten degrees, so that the cable 131 enables contact-making with the electrical conductor 137 in the belt-like drive means 130. With knowledge of the present invention the expert can obviously also realize embodiments with larger looping angles “B”, for example with “B”<20 degrees, preferably with “B”<60 degrees or even with “B”<180 degrees.

FIG. 10 shows a further embodiment of the present invention with a belt-like drive means 140 and a contact means 141 comprising at least one wiping contact element 144. The contact element 144 engages through a groove 146 in the casing of the belt-like drive means and is resiliently pressed, by a settable force by means of a bending spring 148 against an electrical conductor 147 embedded in the belt-like guide means 140. The contact element 144 provided with a curved skid 149 enables contact-making with the electrical conductor 147 via a cable 145.2 and a plug 145.1.

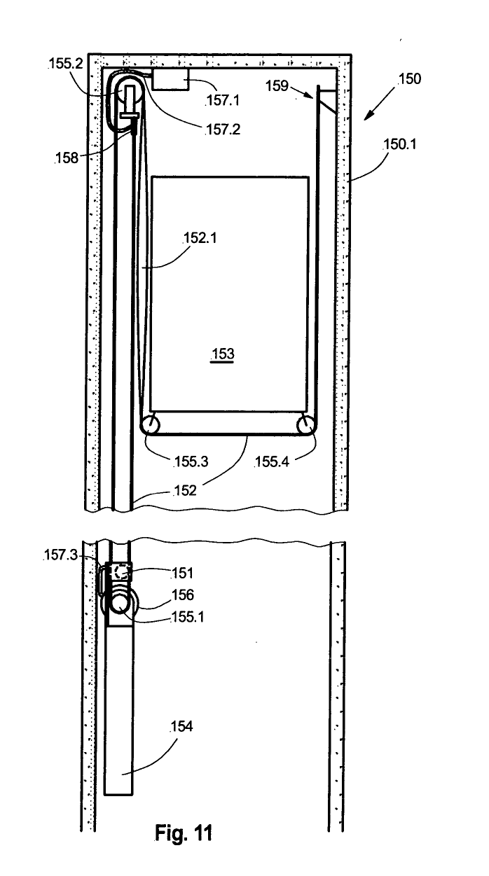

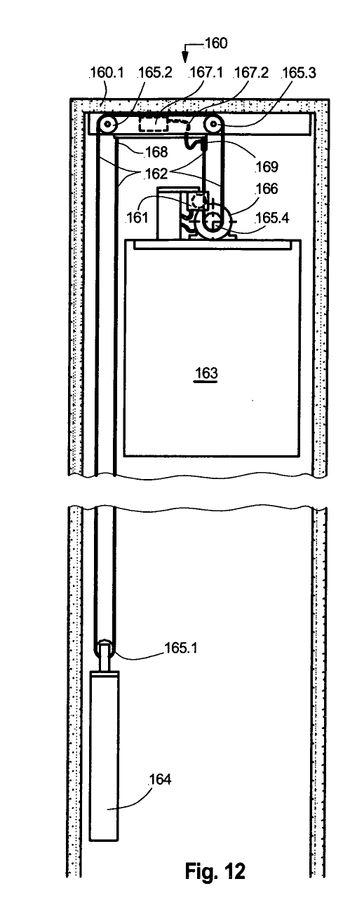

FIGS. 11 and 12 show elevator installations in which the use of equipment according to the present invention is particularly advantageous.

In FIG. 11 an elevator installation 150, which is installed in an elevator shaft 150.1, with an elevator car 153 and a counterweight 154 is schematically illustrated, in which a drive unit 156 is mounted on the counterweight 154. The elevator car and the counterweight are suspended at a belt-like supporting and driving means 152. This driving means runs from a first fixing point 158 downwardly to a drive pulley 155.1 of a drive unit 156 mounted on the counterweight 154, loops around this drive pulley, subsequently extends upwardly to a deflecting roller 155.2 installed in the shaft head of the elevator shaft 150.1, loops around this roller, extends downwardly to a first support roller 155.3 of the elevator car 153, loops around this support roller, runs horizontally to a second support roller 155.4 of the elevator car, loops around this support roller and finally extends upwardly to a second fixing point 159 of the supporting and guiding means. The car and the counterweight are suspended by a 2:1 reeving of the supporting and drive means. Such an embodiment has the advantage that on the one hand the weight of the drive unit 156 contributes to the weight of the counterweight 154 and on the other hand the motor of the drive unit is intensively cooled by travel air flow during travel of the elevator car. The disadvantage of a previously conventional embodiment with a drive unit installed on the counterweight consists in that the power feed to the drive unit had to take place by way of a flexible hanging cable or by way of wiping conductors. This disadvantage is eliminated by the use of a belt-like support means according to the present invention with integrated electrical conductors in combination with a suitable contacting system.

FIG. 11 shows the principle of electrical power feed to the drive unit 156 on the counterweight 154, as follows:

A current cable 157.2 leads from a terminal box 157.1, which box is installed in the shaft head, to the first fixing point 158 of the supporting and driving means. At this fixing point the electrical conductors of the current cable 157.2 are statically connected with the electrical conductors present in or at the supporting and driving means 152. A contact means 151, the construction of which corresponds with, for example, one of the contact means 91, 101 illustrated in FIG. 6A, 6B or 7A, 7B, is fastened to the counterweight 154 above the drive unit 156 mounted on the counterweight. Contact discs present in this contact means 151 conduct the current from the electrical conductors, which are present in the supporting and driving means, by way of a motor cable 157.3 to the motor of the drive unit 156. The supporting and drive means can obviously also contain electrical conductors for the transmission of signals which, for example, can activate an electrically activated safety-brake device at the counterweight.

FIG. 12 schematically shows an elevator installation 160, which is installed in an elevator shaft 160.1, with an elevator car 163 and a counterweight 164, wherein the drive unit 166 is mounted on the elevator car. The elevator car 163 and the counterweight 164 are suspended at a belt-like supporting and driving means 162. This runs from a first fixing point 168 downwardly to a support roller 165.1 of the counterweight 164, loops around this support roller, subsequently extends upwardly to a first deflecting roller 165.2 installed in the shaft head of the elevator shaft 160.1, loops around this roller, extends horizontally to a second deflecting roller 165.3, runs around this, extends downwardly to a drive pulley 165.4 of the drive unit 166 mounted on the elevator car 163, loops around this drive pulley and finally extends upwardly to a second fixing point 169 of the supporting and drive means 162. The car and the counterweight are suspended by a 2:1 reeving of the supporting and driving means. Such an embodiment of an elevator installation has the advantage that the motor of the drive unit 166 during travel of the elevator car is intensively cooled by the travel air flow. Moreover, the drive unit 166 is accessible in a problem-free manner for maintenance, which is of advantage particularly in the case of elevator installations without an engine room. The disadvantage of a previously conventional embodiment with a drive unit installed on the elevator car consists in that the power feed to the drive unit would have to be carried out by way of a flexible hanging cable or by way of wiping conductors. This disadvantage is eliminated by the use of a belt-like support means according to the present invention with integrated electrical conductors in combination with a suitable contact-making system.

FIG. 12 shows the principle of power feed to the drive unit 166 on the elevator car 163 as follows:

A current cable 167.2 leads from a terminal box 167.1 installed in a shaft head to the second fixing point 169 of the supporting and driving means 162. The electrical conductors of the current cable 167.2 are statically connected at this fixing point with the electrical conductors present in or at the supporting and drive means. A contact means 161, the construction of which corresponds with, for example, one of the contact means 81, 101 illustrated in FIG. 5A, 5B or 7A, 7B, is fastened above the drive pulley 165.4 of the drive unit 166 mounted on the elevator car 163. Contact discs present in this contact means 161 conduct the current from the electrical conductors present in or at the supporting and driving means 162 to the motor of the drive unit 166 by way of a motor cable. The supporting and driving means can obviously also contain electrical conductors for the transmission of signals, for example for the transmission of travel commands to the elevator car.

In the case of the elevator installations illustrated in FIG. 11 and FIG. 12 the belt-like supporting and driving means 152, 162 are so installed that on running around the drive pulley, as also the supporting and deflecting rollers, they are always bent in the same sense. It is thus achieved that the electrical conductors integrated in the supporting and driving means are not exposed to any mechanical alternating stresses and thus there is a very positive effect on the service life thereof. In the case of the elevator installation according to FIG. 11 the bending, which is always in the same sense, of the belt-like supporting and driving means 152 is achieved in that this is twisted, in the region of a run 152.1 lying between the deflecting roller 155.2 installed in the shaft head and the first support roller 155.3 of the elevator car, through 180° about the longitudinal axis of this run.

As described in the foregoing, the various belt-like drive means have a front side and a rear side. Particularly preferred are those embodiments in which the groove is disposed on the rear side of the drive means (see, for example, FIGS. 1, 2, 3A, 5A and 7A). When the elevator car is moving the rear side of the drive means runs past the contact means and the contact means can thus produce, from the rear side of the drive means, a permanent contact with the electrically conductive element. These embodiments have the advantage that they are less susceptible to fault than the embodiment (see, for example, FIG. 6A) in which the electrical conductors in the drive means are accessible from the front side.

The contact means according to the present invention can have a wiping contact element which engages in a groove at the drive means. Examples of that are shown in FIG. 8 and FIG. 9. A wiping contact with respect to the electrical conductor is thereby made possible.

Embodiments enabling a non-wiping contact are particularly preferred. An example of that is shown in FIGS. 1, 2, 4, 5A, 5B, 6A, 6B, 7A and 7B. In the case of a suitable refinement of the arrangements shown in these figures, the contact means is set in rotation and there results, as described, a circumferential speed of the contact means in the contact region with the electrical conductor in the drive means which approximately corresponds with the speed of the drive means. In this case, a rolling, permanent contact ideally comes about.

The contact means are preferably rotatably mounted in such a manner that they are set in rotation by contact with the drive means. So-termed co-running contact means are thus concerned in this case.

In connection with FIG. 1 there has been described an elevator installation having contact means at the elevator car. These contact means move with the elevator car in fixed relation relative thereto and produce a wiping or non-wiping—depending on the respective embodiment—contact with conductors in the drive means. This form of embodiment is particularly suitable for elevator cars which are not directly (1:1) suspended, i.e. which have, for example, a cable under-looping.

Tests have shown that between the contact means and the electrically conductive element there should be ensured a contact region which has a length “A” of at least five millimeters parallel to the longitudinal direction of the drive means (see, for example, FIG. 8). A permanent, secure and disturbance-free contact can thereby be guaranteed even in extreme situations. Moreover, contaminations then have a subordinate role.

The present invention can be offered as a retrofit kit, the mounting of which is simple.

The present invention can also be realized in combination with a conventional hanging cable.

The present invention can also be supplemented or extended by communication means operating in a wire-free manner. Thus, for example, the energy supply of the elevator car can be effected by way of the drive means and the signal transmission from the car to the elevator control take place by way of infrared or RF (Radio Frequency).

The present invention can also be used in elevator installations in which more than only one elevator car are moved, for example, in elevator installations in which two elevator cars hang at the same supporting and driving means and mutually serve as balancing weight.

Advantageously those rollers of the elevator installation which belong to the belt guide and to the drive are not used for the supply or derivation of signals and/or energy. The electrically effective elements are separately constructed and specially optimized, whereby safety and cost advantages are achieved.

In order to protect persons against risk due to current-conducting conductors in or at the belt-like drive means, two possibilities are given:

The electrical conductors are so embedded in the drive means that on contact with the drive means no risk arises. In that case they are accessible only by way of a narrow groove.

As already mentioned in connection with FIG. 8, the energy and signal transmission can be operated with voltages of less than fifty volts. Contact safety is given in this case even when the electrical conductors are externally fixed to the circumference of the belt-like drive means.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An installation having a belt-like drive means driven by friction couple with a drive pulley, the drive means comprising:
the drive means extending in a longitudinal direction and having a first surface;
at least one electrically conductive element for transmission of at least one of electrical signals and electrical energy mounted at said first surface and extending in said longitudinal direction of the drive means; and
a contact means fixed relative to of path of movement of said drive means and electrically contacting said at least one electrically conductive element as the drive means moves during operation of the installation.

2. The installation according to claim 1 wherein said first surface does not contact the drive pulley means of the installation.

3. The installation according to claim 1 wherein the installation is an elevator installation, the drive means moves an elevator car and said at least one electrically conductive element transmits said at least one of electrical signals and electrical energy to a system associated with the elevator car.

4. The installation according to claim 1 wherein said first surface has at least one groove formed therein extending parallel to the longitudinal direction of the drive means, said at least one electrically conductive element being positioned in said at least one groove and said at least one groove providing access to said at least one electrically conductive element for said contact means.

5. The installation according to claim 4 wherein the drive means has a front side and a rear side, said first surface being at said rear side, whereby when the drive means is moving relative to said contact means, said contact means remains in permanent contact with said at least one electrically conductive element.

6. The installation according to claim 1 wherein said at least one electrically conductive element is a conductor track plated on said first surface of the drive means.

7. The installation according to claim 1 wherein the drive means wedge-rib belt having ribs are disposed on a front side of the drive means for contact with the drive pulley.

8. The installation according to claim 1 wherein said contact means includes at least one wiping contact element in wiping contact with said at least one electrically conductive element.

9. The installation according to claim 1 wherein said contact means includes at least one rotatably mounted contact element which engages at least partly in a groove formed in the first surface and contacts said at least one electrically conductive element being positioned in said groove.

10. The installation according to claim 9 wherein said rotatably mounted contact element is mounted on or adjacent to a presser roller contacting the drive means.

11. The installation according to claim 10 wherein said presser roller is not included in a group of pulleys and rollers essential for guidance of the drive means.

12. The installation according to claim 10 wherein said presser roller exerts a pressure on the drive means and the drive means loops around the presser roller by at least 5 degrees.

13. The installation according to claim 1 wherein said contact means is arranged at one of an elevator car and a counterweight attached to the drive means, and the drive means moves past the contact means during operation of the installation.

14. The installation according to claim 13 wherein the drive unit is installed on one of said counterweight and said elevator car.

15. The installation according to claim 1 wherein said contact means is arranged in an elevator shaft and the drive means moves relative to said contact means.

16. The installation according to claim 1 wherein the installation is an elevator installation in which the drive means is guided during running over the drive pulley and rollers in the same sense.

17. A method of assembly of the installation according to claim 1 comprising the steps of:
a. mounting the drive means with the at least one electrically conductive element for movement along the path;
b. mounting the contact means adjacent the path and in electrical contact with the at least one electrically conductive element; and
c. maintaining the electrical contact between the contact means and the at least one electrically conductive element during movement of the drive means for the transmission of at least one of electrical signals and electrical energy.

18. A method of transmitting electrical energy or electrical signals in an installation comprising the steps of:
a. providing a drive means having at least one electrically conductive element extending in a longitudinal direction of the drive means;
b. providing a contact means in a region of the drive means; and
c. moving the drive means relative to the contact means while maintaining the contact means in contact with the at least one electrically conductive element and preventing contact between the at least one electrically conductive element and a drive pulley and rollers guiding the drive means.

19. The method according to claim 18 including a step of transmitting electrical energy and electrical signals along the at least one electrically conductive element.

20. The method according to claim 18 including a step of transmitting electrical energy along the at least one electrically conductive element and transmitting electrical signals wirelessly.
